(19) United States
(12) Patent Application Publication
(10) Pub. No.: US 2014/0096261 A1
(43) Pub. Date: Apr. 3, 2014

(54) METHOD AND APPARATUS FOR PROVIDING PRIVACY POLICY FOR DATA STREAM

(71) Applicants: SERGEY BOLDYREV, SODERKULLA (FI); DEBMALYA BISWAS, LAUSANNE (CH)

(72) Inventors: SERGEY BOLDYREV, SODERKULLA (FI); DEBMALYA BISWAS, LAUSANNE (CH)

(73) Assignee: NOKIA CORPORATION, ESPOO (FI)

(21) Appl. No.: 13/632,926

(22) Filed: Oct. 1, 2012

(51) Int. Cl. G06F 21/00

(52) U.S. Cl. CPC G06F 21/00
USPC 726/26

(57) ABSTRACT

An approach for providing a privacy policy for a data stream is described. A privacy policy determination platform causes, at least in part, an interception of at least one data stream accessible to at least one processing element of a stream processing framework. The privacy policy determination platform also causes, at least in part, a parsing of the at least one data stream to determine privacy sensitive data associated with at least one user. The privacy policy determination platform further determines at least one privacy policy for the at least one user, the at least one processing element, the at least one data stream, or a combination thereof based, at least in part, on the privacy sensitive data.

### BACKGROUND

Service providers and device manufacturers (e.g., wireless, cellular, etc.) are continually challenged to deliver value and convenience to consumers by, for example, providing compelling network services. Meantime, large scale data processing applications (e.g., web search, maps, etc.) are increasingly relying on stream based architectures (e.g., S4) for scalability and reliability reasons. Stream processing is vulnerable to being captured or inferred of potentially privacy sensitive information about users. Thus, the users need to control the streams, but it is impractical for average users to understand the privacy consequences of stream processing and define the right policies.

### SOME EXAMPLE EMBODIMENTS

Therefore, there is a need for an approach for providing a privacy policy for a data stream.

According to one embodiment, a method comprises causing, at least in part, an interception of at least one data stream accessible to at least one processing element of a stream processing framework. The method also comprises causing, at least in part, a parsing of the at least one data stream to determine privacy sensitive data associated with at least one user. The method further comprises determining at least one privacy policy for the at least one user, the at least one processing element, the at least one data stream, or a combination thereof based, at least in part, on the privacy sensitive data.

According to another embodiment, an apparatus comprises at least one processor, and at least one memory including computer program code for one or more computer programs, the at least one memory and the computer program code configured to, with the at least one processor, cause, at least in part, the apparatus to cause, at least in part, an interception of at least one data stream accessible to at least one processing element of a stream processing framework. The apparatus is also caused to cause, at least in part, a parsing of the at least one data stream to determine privacy sensitive data associated with at least one user. The apparatus is further caused to determine at least one privacy policy for the at least one user, the at least one processing element, the at least one data stream, or a combination thereof based, at least in part, on the privacy sensitive data.

According to another embodiment, a computer-readable storage medium carries one or more sequences of one or more instructions which, when executed by one or more processors, cause, at least in part, an apparatus to cause, at least in part, an interception of at least one data stream accessible to at least one processing element of a stream processing framework. The apparatus is also caused to cause, at least in part, a parsing of the at least one data stream to determine privacy sensitive data associated with at least one user. The apparatus is further caused to determine at least one privacy policy for the at least one user, the at least one processing element, the at least one data stream, or a combination thereof based, at least in part, on the privacy sensitive data.

According to another embodiment, an apparatus comprises means for causing, at least in part, an interception of at least one data stream accessible to at least one processing element of a stream processing framework. The apparatus also comprises means for causing, at least in part, a parsing of the at least one data stream to determine privacy sensitive data associated with at least one user. The apparatus further comprises means for determining at least one privacy policy for the at least one user, the at least one processing element, the at least one data stream, or a combination thereof based, at least in part, on the privacy sensitive data.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing a privacy policy for a data stream, according to one embodiment;

FIG. 2 is a diagram of components of a privacy policy determination platform, according to one embodiment;

FIG. 3 is a diagram of a data-processing architecture for privacy policies generation and implementation, according to an embodiment;

FIGS. 4A-4E are flowcharts of a processes for providing a privacy policy for a data stream, according to various embodiments.

FIGS. 5A-5D are diagrams of an access control user interface (UI) for streams workflow, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for providing a privacy policy for a data stream are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

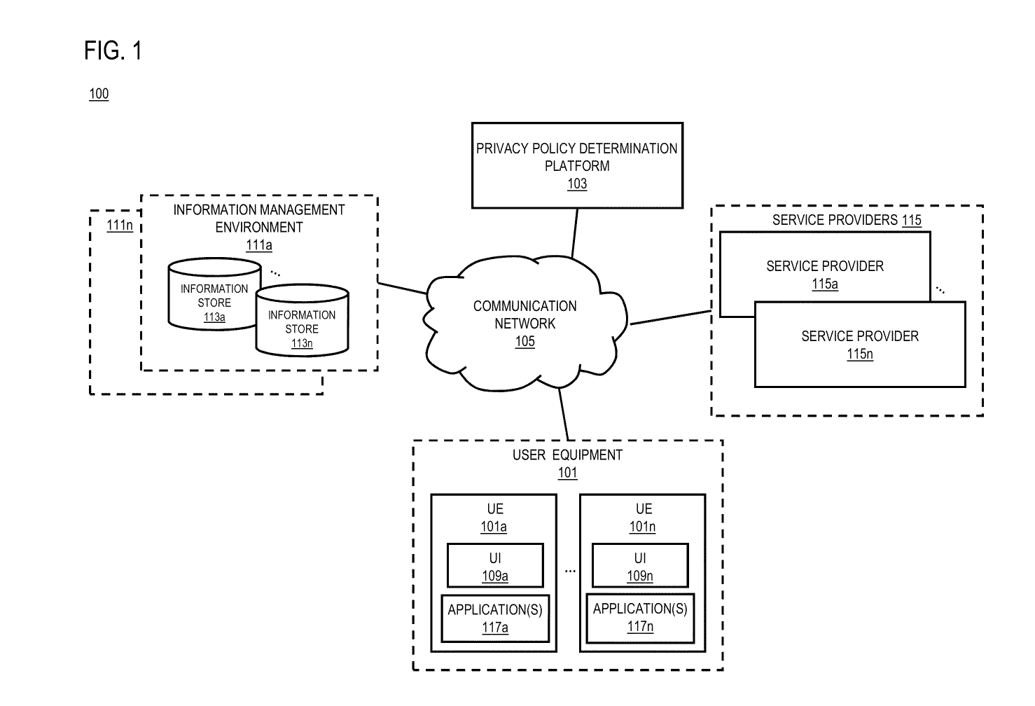

FIG. 1 is a diagram of a system capable of providing a privacy policy for a data stream, according to one embodiment. Large scale data processing applications (e.g., web search, maps, etc.) are increasingly relying on stream based architectures (e.g., S4) for scalability and reliability reasons, and the stream based frameworks are increasingly becoming accepted as the underlying infrastructure for providing profiling or recommendation services to users both in real-time and batch modes. Stream processing architecture comprises subscribing to a data stream, retrieving relevant events (e.g., based on specified objects, such as keywords), and analyzing them. Such architectures support both real-time and server side batch processing of data events. For example, in a computing framework, arbitrary data streams belonging to (or specified by) the user may be profiled for relevant location data and presented to the user. The raw data stream then may be further enhanced by a semantic framework to infer semantic relationships between retrieved location events. Sample data streams that can be profiled include the user's social data streams (e.g., Facebook®, Twitter®, etc.). Such streams allow capturing and inferring of potentially privacy sensitive information about the user. So the user need to control his or her streams being profiled, the type of profiling being performed, and the inferred types of personal information. The preferred enforcement mechanism is to allow the user to specify policies reflecting his restrictions with respect to the use of his data stream. However, in practice, it is impractical for average users to understand the privacy consequences of stream processing and define the right policies.

To address this problem, a system 100 of FIG. 1 introduces the capability to provide a privacy policy for data stream. The privacy policies can be generated in an automated fashion. In one embodiment, relevant privacy policies (e.g., access control) can be generated in a static fashion based on the stream configuration. The users may be provided with initial templates of relevant privacy policies based on the underlying stream processing implementation—with the possibility for users to further tune the generated policies, if required. The policies templates may be generated based on the streams configuration scripts.

In one embodiment, users may be provided with information in respect to the privacy implications of their data as processed (in both real time and batches) by the stream processing application. The users may be presented with details of the relevant data streams on which they would like to impose restrictions. A privacy policies generator user interface can be presented to allow users to control the specific aspect that is being violated in the privacy implications display. Further, the data stream may be processed at run-time to capture the “actual” data accessed as compared to the static “max” that can potentially be accessed. The stream data flow may be intercepted and evaluated to present the corresponding privacy implication to the user. When some privacy violations are detected, the users may be presented with a customized policies generator user interface where they can set policies to control that category.

As shown in FIG. 1, the system 100 comprises a user equipment (UE) 101a-101n (collectively, 101) having connectivity to the privacy policy determination platform 103 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

The information stores 113a-113n (collectively, 113) in information management environment 111a-111n (collectively, 111) may contain the user specific streams (e.g. online behavior stream, user social streams, phone sensor streams, etc.) and/or generic streams (e.g., non-user social streams, news streams, knowledge streams, etc.). Some user specific streams may be obtained from the UE 101. The UE 101 may request a service to the service providers 115 via applications 117a-117n (collectively, 117) and the service providers 115 or the applications 117 may try to access the data streams in the information stores 113. Before the service providers 115 or the applications 117 access the data streams, the privacy policy determination platform 103 may intercept the data streams to determine privacy policies for the data streams. The privacy police determination platform 103 may allow users to control privacy impact factors of the privacy policies via user interfaces (UIs) 109a-109n (collectively 109) on the UE 101.

By way of example, the UE 101, the privacy policy determination platform 103, information management environment 111, and service providers 115 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

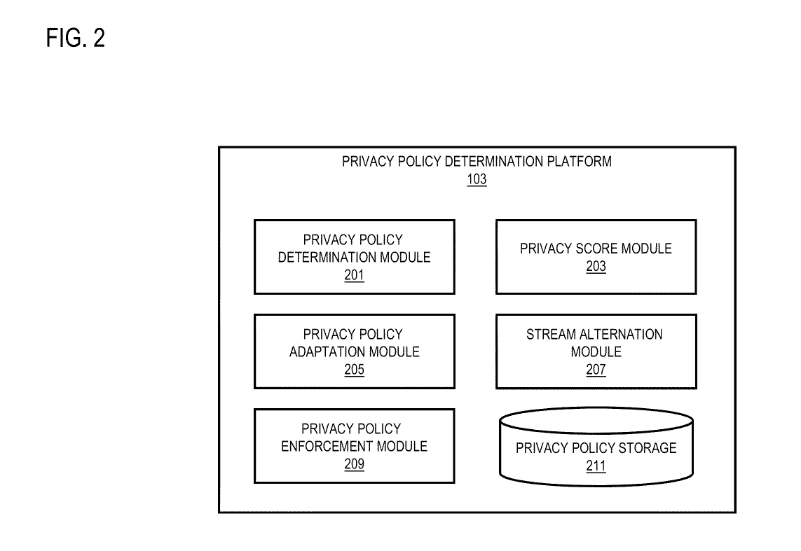

FIG. 2 is a diagram of the components of the privacy policy determination platform 103, according to one embodiment. By way of example, the privacy policy determination platform 103 includes one or more components for providing a privacy policy for a data stream. It is contemplated that the functions of these components may be combined in one or more components or performed by other components of equivalent functionality. In this embodiment, the privacy policy determination platform 103 includes a privacy policy determination module 201, a privacy score module 203, a privacy policy adaptation module 205, a stream alternation module 207, a privacy policy enforcement module 209, and a privacy policy storage 211.

In one embodiment, the privacy policy determination module 201 may cause an interception of data stream accessible to a processing element of a stream processing framework. The interception of data stream may include receiving a copy of the data stream or filtering the data stream itself. The data stream may be accessible to the processing element if the processing element is allowed to extract at least a portion of the data stream. The privacy policy determination module 201 may also cause a parsing of the data stream to determine privacy sensitive data associated with a user. The parsing of the data stream may include breaking or separating the data stream into pieces of data by types, categories, or etc. for privacy evaluation. The privacy sensitive data may be determined based on privacy policies. Each of the parsed data or data sets may be evaluated with respect to privacy sensitivity based on the privacy policies. The privacy policy determination module 201 may further determine a privacy policy for the user, the processing element, and/or the data stream based on the privacy sensitive data. The privacy policy may include rules, instructions, and restrictions for processing a user's privacy sensitive data. Privacy sensitive data may be data that the user does not want to share with or disclose to others, thereby prohibiting others' access to the data. In determining the privacy policy, information about the user, the processing element, the data stream, etc. may be taken as factors. The privacy policy may be determined with respect to levels of abstraction of the privacy sensitive data. In addition, the privacy policy determination module 201 may cause an initiation of the interception of the data stream, the processing of the data stream, and/or the determining of the privacy policy at a run-time of the at least one processing element. The run-time processing may be based on the actual data.

In one embodiment, the privacy score module 203 may determine environmental conditions associated with the user and the privacy policy may be based on the environmental conditions. The environmental condition may include publicity, availability (to public), etc. of the data. The privacy policy may be determined based on publicity or availability of the user data in public domain. The privacy score module 203 may also process the privacy sensitive data, and/or the environmental conditions to determine a privacy score and the privacy policy may be determined based on the privacy score. The privacy score may reflect degree of privacy. Higher privacy score may represent high degree of privacy and lower privacy score may represent lower degree of privacy. The privacy score may be calculated based on weight of the privacy sensitivity and/or the environmental conditions.

In one embodiment, the policy adaptation module 205 may determine that other processing elements have access to the at least one data stream. The other processing element may be a processing element other than the processing elements that has been determined with its privacy policy. If the other element trying to extract data from the data stream, the other processing element's access to the data stream may be determined. The policy adaptation module 205 may further cause an adaptation of the privacy policy to other processing elements. The adaptation of the privacy policy to other processing element may include applying same rules, instructions, restrictions, etc. under the same privacy policy, which has been adopted by previous or another processing element, to the other processing elements.

In one embodiment, the stream alternation module 207 may determine that the privacy policy causes a restriction of a use of the data stream by the processing element. The stream alternation module 207 may also determine an alternate data stream to substitute for the data stream. The alternate data stream may be a data stream other than the data stream access to which has been restricted by the privacy policy.

In one embodiment, the privacy policy enforcement module 209 may cause a recommendation of the privacy policy to the user. The privacy policies determined in the privacy policy determination module 201 may be recommended for a user selection and adaptation to the processing element. The recommendation may allow the user an option to control the privacy impact factors of the privacy policies. The privacy impact factors may be visualized for a user control through a user interface. The privacy policy enforcement module 209 may also cause an enforcement of the privacy policy based on an acceptance input for the recommendation by the user. The enforcement of the privacy policy may be applying the rules, instructions, restrictions, etc. to the processing elements so that the privacy policy is in effect.

In one embodiment, the privacy policy storage 211 may store one or more privacy policies in files. The privacy policies may be pre-defined or updated at real-time. The privacy policies may include rules, instructions, restrictions, etc. with respect to users, data streams, specific data, processing elements, etc.

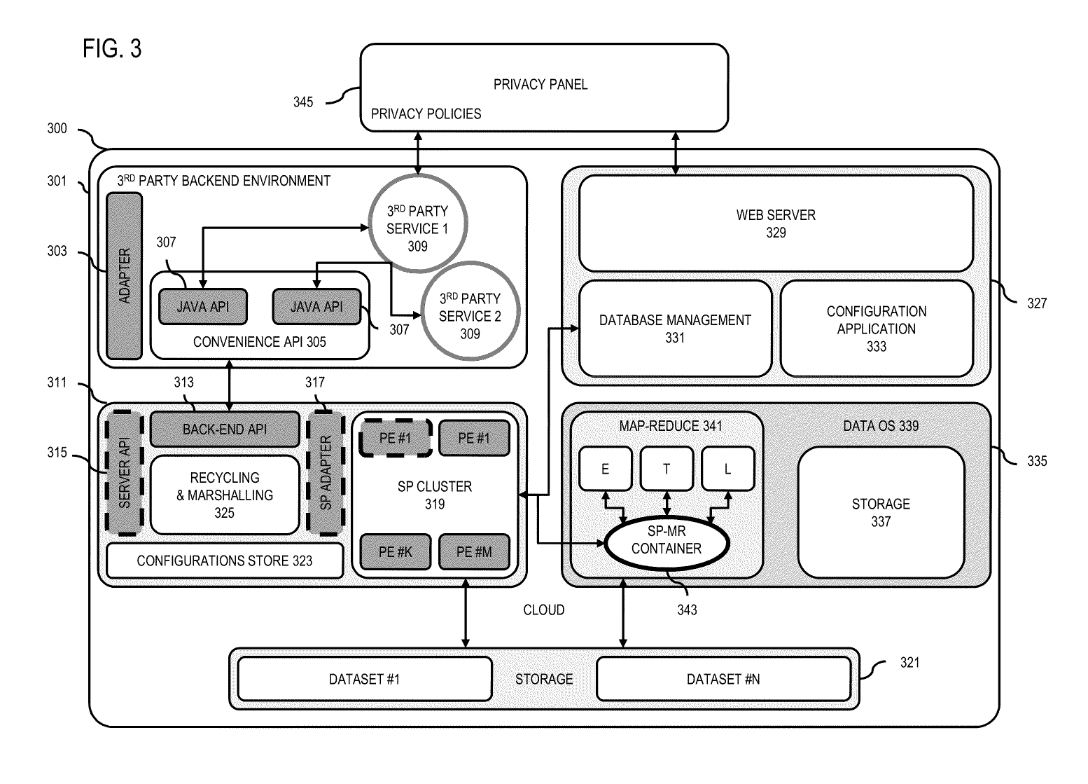

FIG. 3 is a diagram of a data-processing architecture for privacy policies generation and implementation, according to an embodiment. In one embodiment, the architecture 300 may utilize a third party backend environment 301 for communicating and/or processing various data streams, programming interface, service requests, and the like. In various embodiments, the third party backend environment 301 may include various components, for example, an adaptor 303, a convenience API module 305 (including one or more Java APIs 307), and one or more third party services 309, wherein the Java APIs 307 may be utilized for communication and/or programming interface with a processing platform 311. In various embodiments, the processing platform 311 may include a back-end API 313, a server API 315, a stream processing (SP) (e.g., S4, Storm, or the like) adapter 317, and the like, wherein the SP adapter 317 (e.g., a client) allows third party clients to send and receive events from an stream processing cluster (or engine) 319. In one embodiment, the processing platform 311 includes a stream processing cluster 319 (“dynamic process”) which may further include an S4 engine and various PEs with access to one or more data storage 321, which may store various data sets (e.g., user data, sensor data, historical data, etc.). In general, the stream processing cluster 319 is a general-purpose distributed platform that allows for development of applications for processing continuous unbounded streams of date. Further, the processing platform 311 may include a configurations storage 323 including various configurations (e.g., service provider, processing, etc.) and a recycling and marshaling module 325 whereby one or more processes may be utilized to transform memory representation of an object to a data format suitable for storage or transmission whereby the data may need to be moved between different parts of one or more processes.

In one embodiment, the architecture 300 includes a system front-end 327 comprising web server 329 (e.g., Apache) and database management 331 (e.g., MySQL) and configuration applications 333 (e.g., Tomcat). Further, the system front-end 327 includes a static processing module 335 which may include one or more data storage 337, an data operating system 339, and a distributed processing and management module 341 (“static process”) (e.g. Hadoop), which may utilize a Map-Reduce (MR) process including extract, transform, and load (ETL) processes on static data in a SP-MR container 343. In one embodiment, one or more PEs are transferred between the stream processing cluster 319 and distributed processing platform 311 via the SP-MR container 343 including data, code, configuration, etc. The SP-MR container 343 may marshal or unmarshal the PEs, where marshalling may be a process of encoding an object for sharing, sending, and/or communicating the object to one or more component, processes, and the like of a computer and/or a network and unmarshalling may be a process of decoding the object that was marshalled. Thus, the privacy policies data may be received from the distributed processing and management module (MR) 341. It is noted that various elements of the architecture 300 may be implemented in one or more modules, for example, the stream processing cluster 319 (“dynamic process”) and distributed processing platform 311 (“static process”) may be implemented in one or more modules for achieving substantially same functionality. The third party service 309 may access a privacy panel 345 which controls the privacy policies. The panel may be a webpage or a web application developed in programming languages such as HTML5, JS, CSS, etc. The privacy panel may communicate with the web server 329.

In one embodiment the data streams are processed by processing elements (PEs) which read streams, retrieve specific data items (based on keywords), and then output results or pass the transformed data to the next PE. A PE can be an application with user given access permission to data streams. The PE can also be a specialized application profiling or recommending services. The user may be able to approve or decline subset of the input stream. A sample PE configuration file is as following:

<bean id=“locationNewsPE” class=“io.s4.processor.LocationPE”>

<property name=“id” value=“ locationNewsPE”/>
<property name=“keys”>

<list>

<value>Facebook location</value>
<value>News location</value>

</list>

</property>
</property>
<property name=“outputStreamName” value=“LocationNews”/>
<property name=“outputClassName”

value=“io.s4.example.speech01.LocationNews”/>

<property name=“dispatcher” ref=“dispatcher”/>

</bean>

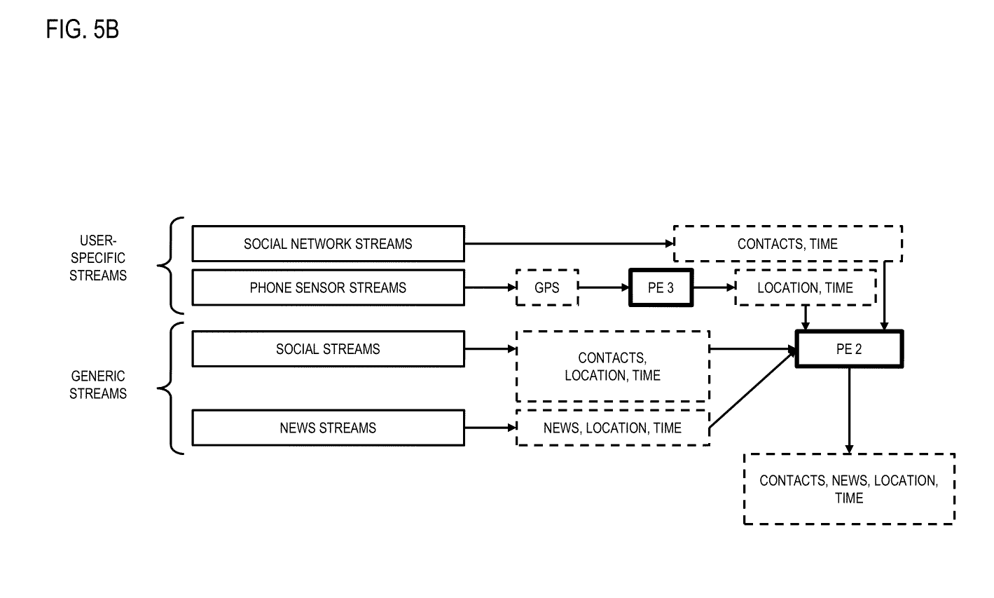

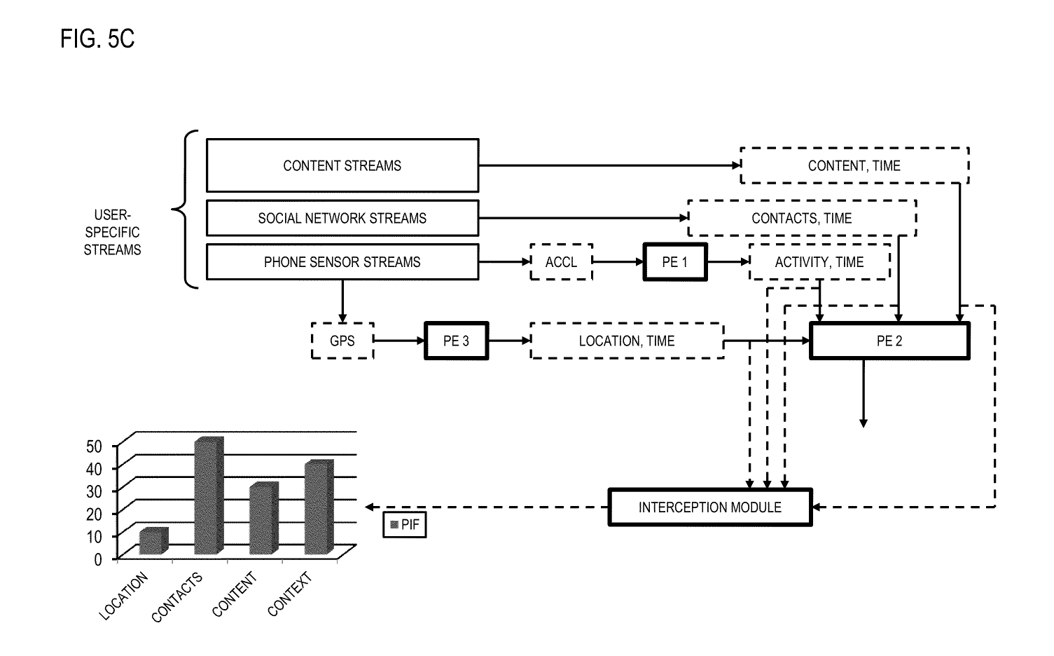

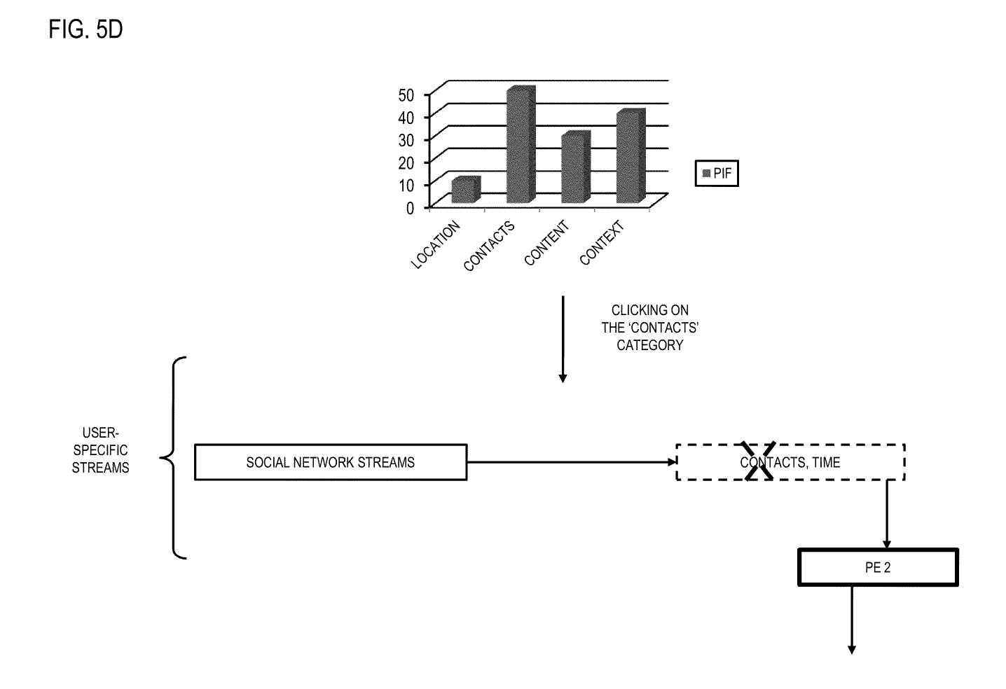

The configuration file describes a PE which extracts “location” based words from the user's Facebook stream and combines them with a generic news stream to output live news relevant to the user's location. Parsing the configuration file provides information about the corresponding PE, including the input streams accessed by the PE, the data items or events extracted based on the specified keywords, the output data types, interaction with other PEs (e.g., a PE can both receive as well as pass-on data events to other PEs), etc. Parsing the configuration file may also be used as a static mechanism to compute the “max” privacy leakage, as an alternative in case the interception of data stream at run-time is not feasible. Further, the configuration file contains the stream processing schema including information about streams involved and their interaction details. Thus, the configuration file can also be used as a run-time processing mechanism providing underlying stream information for displaying the access control user interface (UI) screen in FIG. 5.

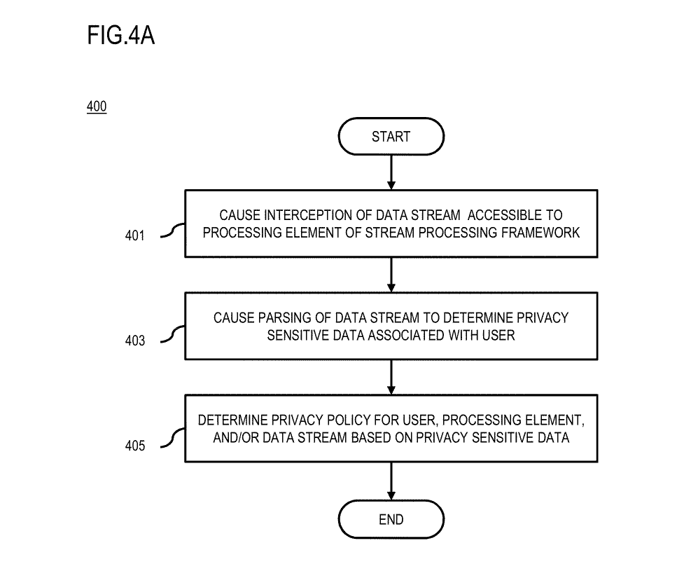

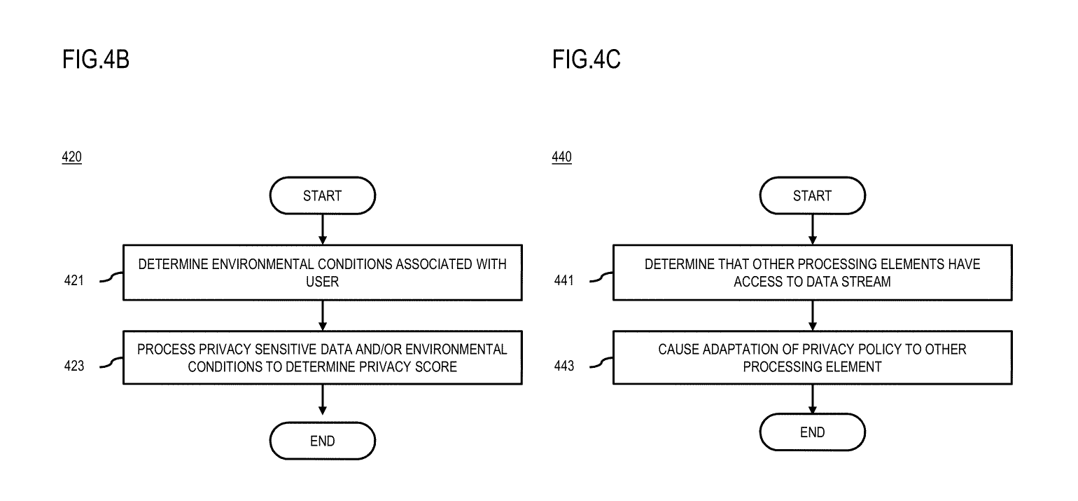

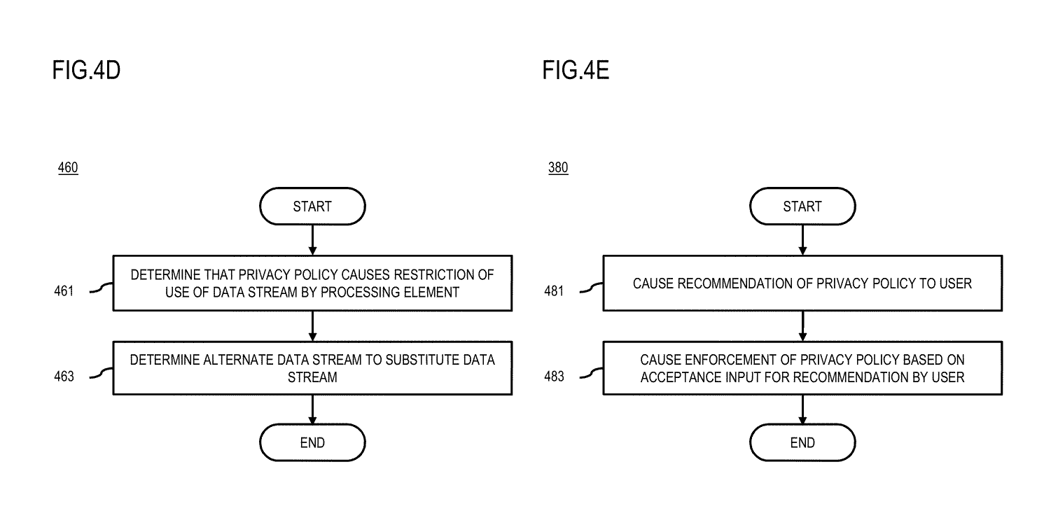

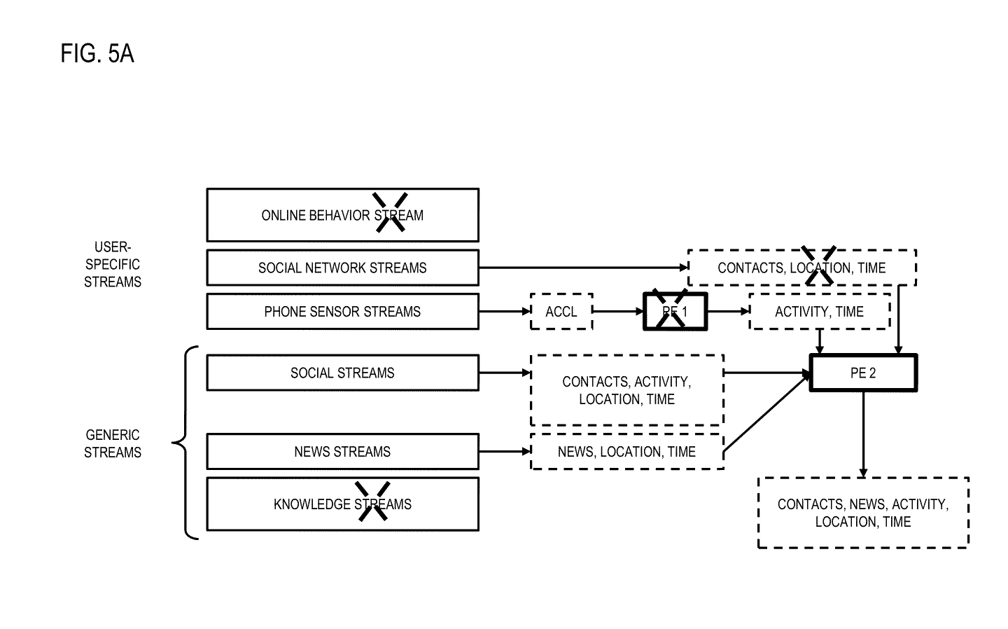

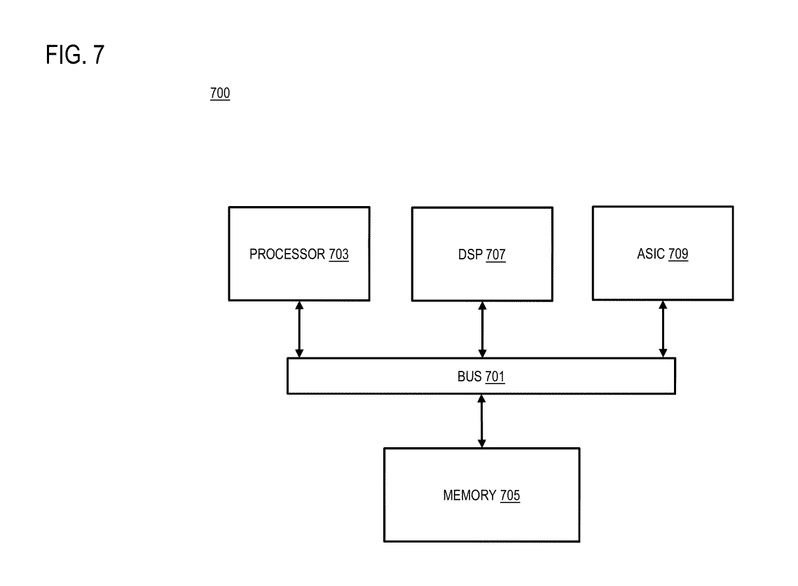

FIGS. 4A-4E are flowcharts of a processes for providing a privacy policy for a data stream, according to various embodiments. In one embodiment, the privacy policy determination platform 103 performs the process 400, 420, 440, 460 and 480 are implemented in, for instance, a chip set including a processor and a memory as shown in FIG. 7.

FIG. 4A is a flowchart of a process for processing data stream to determine a privacy policy, according to one embodiment. In step 401, the privacy policy determination platform 103 may cause, at least in part, an interception of at least one data stream accessible to at least one processing element of a stream processing framework. The interception of data stream may include receiving a copy of the data stream or filtering the data stream itself. The data stream may be accessible to the at least one processing element if the at least processing element is allowed to extract at least a portion of the data stream. By way of example, when an application requests a user's social network data (e.g., contacts, location, time, etc.), the data may be intercepted by the privacy policy determination platform 103 for evaluation of data privacy before the data stream is accessed by the application.

In step 403, the privacy policy determination platform 103 may cause, at least in part, a parsing of the at least on data stream to determine privacy sensitive data associated with at least one user. The parsing of the at least one data stream may include breaking/separating the at least one data stream into pieces of data by types, categories, or etc. for privacy evaluation. The privacy sensitive data may be determined based on privacy policies. By way of example, when the user's social network data stream is intercepted by the privacy policy determination platform 103, the social network data stream may be parsed into data or data sets (e.g., contacts data, location data, time data, etc.) optimal for evaluation. Each of the parsed data or data sets may be evaluated with respect to privacy sensitivity based on the privacy policies.

In step 405, the privacy policy determination platform 103 may determine at least one privacy policy for the at least one user, the at least one processing element, the at least one data stream, or a combination thereof based, at least part, on the privacy sensitive data. The privacy policy may include rules, instructions, and restrictions for processing a user's privacy sensitive data. Privacy sensitive data may be data that the user does not want to share with or disclose to others, thereby prohibiting others' access to the data. In determining the privacy policy, information about the user, the processing element, the data stream, etc. may be taken as factors. By way of example, when a user's social network data stream is intercepted for privacy evaluation, the privacy policy determination platform 103 may determine at least one privacy policy that covers the user's sensitive data such as user's contacts information. The privacy policy may include rules, instructions or restrictions regarding the user's contacts information. In that way, the privacy policy determination platform 103 can determine a privacy policy.

FIG. 4B is a flowchart of a process for processing environmental conditions and privacy sensitive data to determine a privacy score, according to one embodiment. In step 421, the privacy policy determination platform 103 may determine one or more environmental conditions associated with the at least one user. The at least one privacy policy is further based, at least in part, on the one or more environmental conditions. The environmental condition may include publicity, availability (to public), etc. of the data. The privacy policy may be determined based on publicity or availability of the user data in public domain. For example, if a user's contact information is publically available, less strict privacy policy may be selected.

In step 423, the privacy policy determination platform 103 may process and/or facilitate a processing of the privacy sensitive data, the one or more environmental conditions, or a combination thereof to determine at least one privacy score. The at least one privacy policy is based, at least in part, on the at least one privacy score. The at least one privacy score may reflect degree of privacy. Higher privacy score may represent high degree of privacy and lower privacy score may represent lower degree of privacy. The privacy score may be calculated based on weight of the privacy sensitivity and/or the environmental conditions. For example, where privacy sensitivity of the data is ‘x’ and weight of the privacy sensitivity is ‘a’ and degree of the environmental condition is ‘y’ and weight of the environmental condition is ‘b, the formula for the privacy score may be similar to “score (p)=a*x+b*y.” In that way the privacy policy determination platform 103 can determine the privacy score.

FIG. 4C is a flowchart of a process for causing an adaptation of a privacy policy to other processing element, according to one embodiment. In step 441 the privacy policy determination platform 103 may determine that one or more other processing elements have access to the at least one data stream. Other processing element may be a processing element other than the processing elements that has been determined with its privacy policy. If the other element trying to extract data from the data stream, the other processing element's access to the data stream may be determined. For example, when an application's private policy to user's social network data is determined and the other application is trying to access the same data, the privacy policy determination platform 103 may determine that the other application has access to the data.

In step 443, the privacy policy determination platform 103 may cause, at least in part, an adaptation of the at least one privacy policy to the one or more other processing elements. The adaptation of the privacy policy to other processing element may include applying same rules, instructions, restrictions, etc. under the same privacy policy, which has been adopted by previous or another processing element, to the other processing elements. By way of example, an application may adopt a privacy policy that restricts access to the user's location information from the user's social network data stream and other application may try to access the same data. Then, the privacy policy determination platform 103 may apply same privacy policy for the other application to maintain the consistency throughout the data flow, thereby restricting access to the location information from the user's social network data stream. In that way, the privacy policy determination platform 103 may cause adaptation of privacy policy to other processing element.

FIG. 4D is a flowchart of a process for alternating data stream based on restriction of a privacy policy, according to one embodiment. In step 461, the privacy policy determination platform 103 may determine that the at least one privacy policy causes, at least in part, a restriction of a use of the at least one data stream by the at least one processing element. By way of example, a privacy policy on a user's social network data stream may restrict the access to the user's location information by an application.

In step 463, the privacy policy determination platform 103 may determine at least one alternate data stream to substitute for the at least one data stream. The alternate data stream may be a data stream other than the data stream access to which has been restricted by the privacy policy. By way of example, where the access to the user's location information from the user's social network data stream is restricted, the user's phone sensor stream may be used as an alternate data stream to access the user's location information. In that way, the privacy policy determination platform 103 can substitute alternate data stream for the restricted data stream.

FIG. 4E is a flowchart of a process for causing enforcement of a private policy based on recommendation of the privacy policy. In step 481, the privacy policy determination platform 103 may cause, at least in part, a recommendation of the at least one privacy policy to the at least one user. The one or more privacy policies determined in the previous steps may be recommended for a user selection and adaptation to the processing element. The recommendation may allow the user an option to control the privacy impact factors of the privacy policies. The privacy impact factors may be visualized for a user control through a user interface. By way of example, the privacy impact factors (e.g., location, contacts, content, context, etc.) of the privacy policy for the social network data stream or phone sensor stream may be presented in a bar graph as shown in FIGS. 5C and 5D.

In step 483, the privacy policy determination platform 103 may cause, at least in part, an enforcement of the at least one privacy policy based, at least in part, on an acceptance input for the recommendation by the at least one user. The enforcement of the privacy policy may be applying the rules, instructions, restrictions, etc. to the processing elements so that the privacy policy is in effect. By way of example, when the user accepted the recommendation of privacy policy presented to the user in step 481, the privacy policy may be enforced so that the rules, instructions, restrictions regarding the access to user information from the social network data streams may be applied to the application accessing the user information.

In one embodiment, the privacy policy determination platform 103 may determine the at least one privacy score, the at least one privacy policy, or a combination thereof based, at least in part, on one or more categories of the privacy sensitive data. The one or more categories include, at least in part, a location category, a contacts category, a content category, a context category, or a combination thereof. By way of example, the privacy score and/or the privacy policy on the user's social network data stream may be determined based on privacy sensitivity of each category of accessible data.

In one embodiment, the privacy policy determination platform 103 may determine one or more outputs of the at least one processing element. The at least one privacy policy may be further based, at least in part, on the one or more outputs. By way of example, an application which accessed a location data from user's social network data stream may process the location data and output news data associate with the location. Based on the news data, which may be privacy sensitive to the user, corresponding privacy policy may be determined for the news data and/or the application have access to the news data.

In one embodiment, the privacy policy determination platform 103 may determine the at least one privacy policy with respect to one or more levels of abstraction of the privacy sensitive data. By way of example, as shown in FIG. 5A, the privacy policy may be imposed on data streams (e.g., online behavior stream and knowledge streams), processing elements (e.g., PF 1), and specific data (e.g., contacts, location, time).

In one embodiment, the privacy policy determination platform 103 may cause, at least in part, an initiation of the interception of the at least one data stream, the processing of the at least one data stream, the determining of the at least one privacy policy, or a combination thereof at a run-time of the at least one processing element. The run-time processing may be based on the actual data. The availability of the actual data may depend on quality of data stream, quality of sensors, etc. Also, the actual privacy sensitiveness of accessed data may depend on environmental conditions. For example, a user's location data from a user's social network stream can be more sensitive if the location data is profiled in a sparsely populated area, or less sensitive if the user is actually moving quite fast (in which case the user's current position does not have much significance). Also, the privacy sensitiveness may vary based on time.

The processes described herein for providing a privacy policy for a data stream may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIGS. 5A-5D are diagrams of an access control user interface for streams workflow, according to various embodiments. FIG. 5A illustrates the dataflow of a sample PE 2 that takes input from various user data streams (e.g., social network services, phone sensors, etc.), extracts user current location and activity (e.g., output provided by another PE 1), and co-relates this information with public data stream to provide real-time relevant information (e.g., news related to the user's current location and activity). In one embodiment, multiple streams may provide same type of data. In FIG. 5A, the user's location is inferred from the user's Facebook stream or phone stream (e.g., GPS information). The restrictions are denoted by crosses. In FIG. 5A, online behavior stream, knowledge streams, PE1, and contacts-location-time (from social network streams) are restricted.

FIG. 5B describes the consistent stream workflow of FIG. 5A with alternate “Location” stream added where “Activity” related events processing removed. With respect to the user's location, as this information can also be obtained from the user's phone GPS stream, the PE 2 can continue to provide location related events as output by substituting the input PE 1 in FIG. 5A with a location related PE3.

FIG. 5C describes an interception module displaying privacy impact of PE 2, according to one embodiment. The actual data accessed by each PE is intercepted and transformed to a privacy impact factor (PIF). The privacy impact factor is computed based on the intercepted streams data and prevailing environmental conditions. In FIG. 5C, the privacy impact factor is categorized into four categories, location, contacts (e.g., address book, social contacts, etc.), content (e.g., audio, picture, video, etc.), context (e.g., activity). With the PIF visualization, the user notices that the privacy impact factor with respect to a specific category is very high (e.g., Location), clicking on that category leads it to a customized view of the access control user interface (in FIG. 5A) allowing the user to specify restrictions corresponding to the chosen category only.

FIG. 5D describes a customized access control user interface specific to the chosen category (e.g., contacts), according to one embodiment. By clicking on the “Contacts” category, the user is able to restrict access to the contacts information from user specific social network streams. Thus, PE 2 will be able to process only time information.

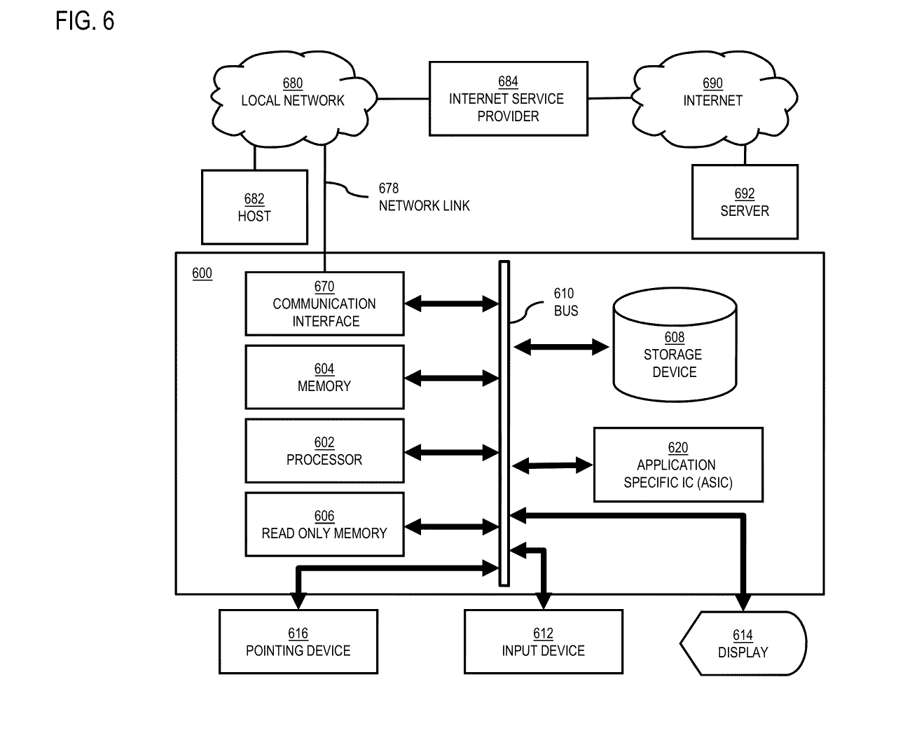

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to provide a privacy policy for data stream as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of providing a privacy policy for a data stream.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to provide a privacy policy for data stream. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for providing a privacy policy for a data stream. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for providing a privacy policy for a data stream, is provided to the bus 610 for use by the processor from an external input device 612, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for providing a privacy policy for a data stream to the UE 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to provide a privacy policy for data stream as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of providing a privacy policy for a data stream.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to provide a privacy policy for data stream. The memory 705 also stores the data associated with or generated by the execution of the inventive steps.

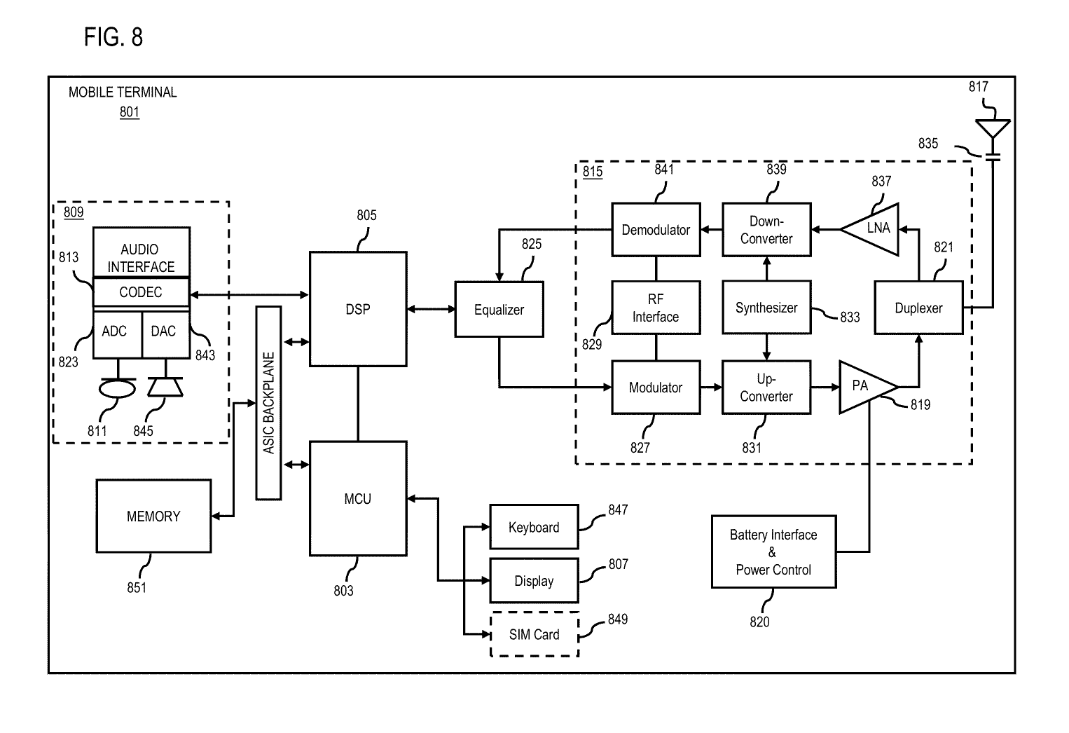

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of providing a privacy policy for a data stream. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of providing a privacy policy for a data stream. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to provide a privacy policy for data stream. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
an interception of at least one data stream accessible to at least one processing element of a stream processing framework;
a parsing of the at least one data stream to determine privacy sensitive data associated with at least one user; and
at least one determination of at least one privacy policy for the at least one user, the at least one processing element, the at least one data stream, or a combination thereof based, at least in part, on the privacy sensitive data.

2. A method of claim 1, wherein the (1) data and/or (2) information and/or (3) at least one signal are further based, at least in part, on the following:
at least one determination of one or more environmental conditions associated with the at least one user,
wherein the at least one privacy policy is further based, at least in part, on the one or more environmental conditions.

3. A method of claim 2, wherein the (1) data and/or (2) information and/or (3) at least one signal are further based, at least in part, on the following:
a processing of the privacy sensitive data, the one or more environmental conditions, or a combination thereof to determine at least one privacy score,
wherein the at least one privacy policy is based, at least in part, on the at least one privacy score.

4. A method of claim 3, wherein the (1) data and/or (2) information and/or (3) at least one signal are further based, at least in part, on the following:
at least one determination of the at least one privacy score, the at least one privacy policy, or a combination thereof based, at least in part, on one or more categories of the privacy sensitive data,
wherein the one or more categories include, at least in part, a location category, a contacts category, a content category, a context category, or a combination thereof.

5. A method of claim 1, wherein the (1) data and/or (2) information and/or (3) at least one signal are further based, at least in part, on the following:
at least one determination of one or more outputs of the at least one processing element,
wherein the at least one privacy policy is further based, at least in part, on the one or more outputs.

6. A method of claim 1, wherein the (1) data and/or (2) information and/or (3) at least one signal are further based, at least in part, on the following:
at least one determination of the at least one privacy policy with respect to one or more levels of abstraction of the privacy sensitive data.

7. A method of claim 1, wherein the (1) data and/or (2) information and/or (3) at least one signal are further based, at least in part, on the following:
at least one determination that one or more other processing elements have access to the at least one data stream; and
an adaptation of the at least one privacy policy to the one or more other processing elements.

8. A method of claim 1, wherein the (1) data and/or (2) information and/or (3) at least one signal are further based, at least in part, on the following:
at least one determination that the at least one privacy policy causes, at least in part, a restriction of a use of the at least one data stream by the at least one processing element; and
at least one determination of at least one alternate data stream to substitute for the at least one data stream.

9. A method of claim 1, wherein the (1) data and/or (2) information and/or (3) at least one signal are further based, at least in part, on the following:
a recommendation of the at least one privacy policy to the at least one user;
an enforcement of the at least one privacy policy based, at least in part, on an acceptance input for the recommendation by the at least one user.

10. A method of claim 1, wherein the (1) data and/or (2) information and/or (3) at least one signal are further based, at least in part, on the following:
an initiation of the interception of the at least one data stream, the processing of the at least one data stream, the determining of the at least one privacy policy, or a combination thereof at a run-time of the at least one processing element.

11. An apparatus comprising:
at least one processor; and
at least one memory including computer program code for one or more programs,
the at least one memory and the computer program code configured to, with the at least one processor, cause the apparatus to perform at least the following,
cause, at least in part, an interception of at least one data stream accessible to at least one processing element of a stream processing framework;
cause, at least in part, a parsing of the at least one data stream to determine privacy sensitive data associated with at least one user; and
determine at least one privacy policy for the at least one user, the at least one processing element, the at least one data stream, or a combination thereof based, at least in part, on the privacy sensitive data.

12. An apparatus of claim 11, wherein the apparatus is further caused to:
determine one or more environmental conditions associated with the at least one user,
wherein the at least one privacy policy is further based, at least in part, on the one or more environmental conditions.

13. An apparatus of claim 12, wherein the apparatus is further caused to:
process and/or facilitate a processing of the privacy sensitive data, the one or more environmental conditions, or a combination thereof to determine at least one privacy score,
wherein the at least one privacy policy is based, at least in part, on the at least one privacy score.

14. An apparatus of claim 13, wherein the apparatus is further caused to:
determine the at least one privacy score, the at least one privacy policy, or a combination thereof based, at least in part, on one or more categories of the privacy sensitive data,
wherein the one or more categories include, at least in part, a location category, a contacts category, a content category, a context category, or a combination thereof.

15. An apparatus of claim 11, wherein the apparatus is further caused to:
determine one or more outputs of the at least one processing element,
wherein the at least one privacy policy is further based, at least in part, on the one or more outputs.

16. An apparatus of claim 11, wherein the apparatus is further caused to:
determine the at least one privacy policy with respect to one or more levels of abstraction of the privacy sensitive data.

17. An apparatus of claim 11, wherein the apparatus is further caused to:
determine that one or more other processing elements have access to the at least one data stream; and
cause, at least in part, an adaptation of the at least one privacy policy to the one or more other processing elements.

18. An apparatus of claim 11, wherein the apparatus is further caused to:
determine that the at least one privacy policy causes, at least in part, a restriction of a use of the at least one data stream by the at least one processing element; and
determine at least one alternate data stream to substitute for the at least one data stream.

19. An apparatus of claim 11, wherein the apparatus is further caused to:
cause, at least in part, a recommendation of the at least one privacy policy to the at least one user;
cause, at least in part, an enforcement of the at least one privacy policy based, at least in part, on an acceptance input for the recommendation by the at least one user.

20. An apparatus of claim 11, wherein the apparatus is further caused to:
cause, at least in part, an initiation of the interception of the at least one data stream, the processing of the at least one data stream, the determining of the at least one privacy policy, or a combination thereof at a run-time of the at least one processing element.

21.-48. (canceled)
